(19) United States
(12) Patent Application Publication
(10) Pub. No.: US 2022/0083957 A1
(43) Pub. Date: Mar. 17, 2022

(54) KIOSK DEVICE HAVING STORAGE BINS

(71) Applicant: Hewlett-Packard Development Company, L.P., Spring, TX (US)

(72) Inventors: Gerold Keith Shelton, Boise, ID (US); Kyle James Nottingham, Boise, ID (US); Matthew Frederickson, Spring, TX (US)

(73) Assignee: Hewlett-Packard Development Company, L.P., Spring, TX (US)

(21) Appl. No.: 17/418,212

(22) PCT Filed: May 8, 2019
(86) PCT No.: PCT/US2019/031243

§ 371 Date: Jun. 24, 2021

(51) Int. Cl. G06Q 10/08; G06K 7/10

(52) U.S. Cl. CPC G06Q 10/087; G06Q 20/18; G06K 7/10366

(57) ABSTRACT

In son examples, a kiosk device having storage bins includes a passive radio frequency identification (RFID) reader and a storage bin, where in response to a first item being removed from the storage bin, the RFID reader is to record the removal of the first item via an RFID tag associated with the first item, and in response to a second item being added to the storage bin, the RFID reader is to record the addition of the second item via an RFID tag associated with the second item.

### BACKGROUND

A kiosk can be used as a structure for storing items. The items can be stored in the kiosk until a user wants to utilize an item from the kiosk. For example, a user can retrieve the item from the kiosk and utilize the item for a particular purpose. In some examples, a user can place the item back in the kiosk.

### BRIEF DESCRIPTION OF THE DRAWINGS

FIG. 1 illustrates an example of a kiosk device having storage bins consistent with this disclosure.

FIG. 2 illustrates an example of a kiosk device having storage bins consistent with this disclosure.

FIG. 3 illustrates an example of a storage bin consistent with this disclosure.

FIG. 4 illustrates an example of a kiosk device having storage bins consistent with this disclosure.

FIG. 5 illustrates an example of a controller of a kiosk device having storage bins consistent with this disclosure.

FIG. 6 illustrates an example of a method for a kiosk device having storage bins consistent with this disclosure.

### DETAILED DESCRIPTION

In some examples, kiosks can be interactive. As used herein, the term “kiosk” refers to a structure having a storage area. The storage area can be utilized by the kiosk in performing a particular task when a user interacts with a kiosk. For instance, a user can place an item in the kiosk and the kiosk can perform a task with the item. As another example, a user can interact with the kiosk such that the kiosk allows a user to retrieve an item from the kiosk.

As described above, a kiosk can be utilized by a user to place and/or retrieve items. For instance, a kiosk may include a storage bin having computing devices and/or electronic components for the computing devices. A user can interact with the kiosk to retrieve a computing device and/or a component for use with the computing device.

Some kiosks may temporarily allow retrieval of items for use by a user. Continuing with the example from above, the user can interact with the kiosk to retrieve a component for use with the user's computing device. However, the user may have retrieved the component for a defined period of time. Accordingly, the user can then place the component back in the storage bin of the kiosk once the user is finished using the item.

However, tracking inventory of items stored in a kiosk can be challenging. For example, it can be difficult to have an up to date inventory including a type and/or an amount of items stored in the kiosk. Further, users may not always return items rented and/or loaned from a kiosk (e.g., due to forgetfulness, theft, etc.).

Kiosk devices having storage bins, according to the disclosure, can allow for inventory tracking of items included in a kiosk. For example, the inventory of a storage bin, including a total amount of items in a storage bin, the type of items in a storage bin, and/or an amount of and/or types of items that have been removed (e.g., that are loaned out or rented) from the kiosk, can be tracked. This can ensure an accurate inventory list of items included in a kiosk. Further, items can be associated with users such that those users who have items from the kiosk which have not been returned can be notified and/or charged for such items.

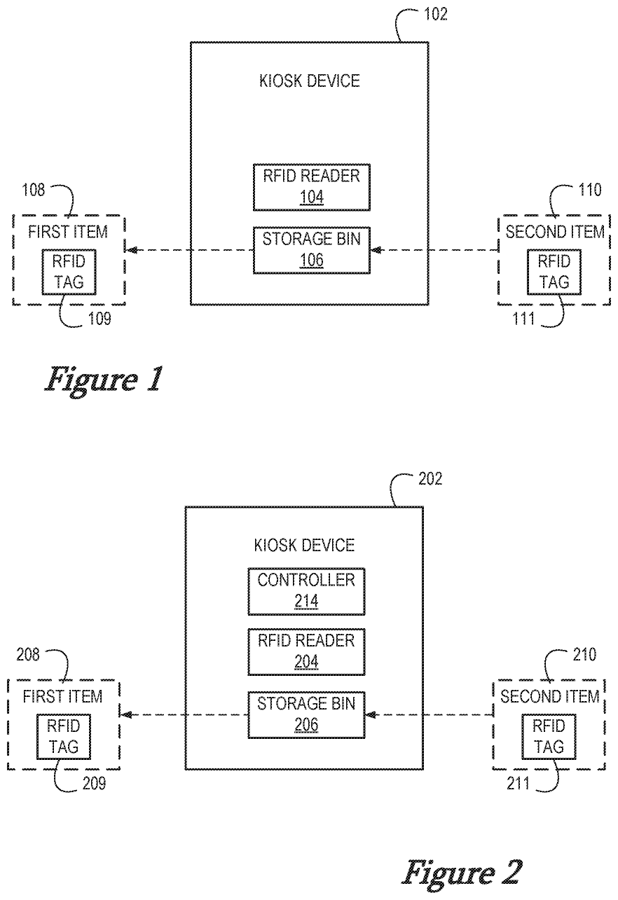

FIG. 1 illustrates an example of a kiosk device 102 having storage bins 106 consistent with this disclosure. The kiosk device 102 can include a radio frequency identification (RFID) reader 104 and a storage bin 106.

As illustrated in FIG. 1, the kiosk device 102 can include the storage bin 106. As used herein, the term “storage bin” refers to an enclosed space to store an item or items. For example, the storage bin 106 can be an enclosed space in which to store items, such as the first item 108 and/or the second item 110, as is further described herein.

In some examples, the storage bin 106 can be a drawer. For example, the storage bin 106 can be a sliding compartment that may be drawn out of a receiving area in order to gain access to the drawer. That is, the storage bin 106 can be drawn out (e.g., by sliding out) of the kiosk device 102 in order to gain access to the storage bin 106. A user can physically draw the storage bin 106 out of the kiosk device 102 and/or the storage bin 106 can be drawn out automatically by an automation mechanism (e.g., by an electrical and/or mechanical mechanism) such that a user can access storage bin 106 to place and/or remove the first item 108 and/or the second item 110, as is further described herein.

In some examples, the storage bin 106 can be located behind a door. For example, the storage bin 106 can be accessed by a user maneuvering the door away from the storage bin 106 such that a user can access the storage bin 106 to place and/or remove the first item 108 and/or the second item 110, as is further described herein. In some examples, the door can be a swinging/rotating door (e.g., a door rotating away from the storage bin 106 about a hinge. In some examples, the door can be a combination swinging and/or sliding door (e.g., a door rotating away from the storage bin 106 about a hinge and then sliding into a slot in the kiosk device 102.

Although the storage bin 106 is described above as being a drawer or being located behind a door, examples of the disclosure are not so limited. For example, storage bin 106 can be combinations thereof (e.g., a drawer located behind a door (swinging and/or sliding)), and/or can be any other type of storage bin.

The kiosk device 102 can include a passive RFID reader 104. As used herein, the term “RFID reader” refers to a device used to collect information from an RFID tag using electromagnetic fields. For example, the RFID reader 104 can be used to collect information from RFID tags 109 and/or 111, associated with first item 108 and/or second item 110, respectively, as is further described herein. As used herein, the term “RFID tag” refers to a device including electronically stored information readable by an RFID reader.

The RFID reader 104 can be a passive RFID reader. For example, the passive RFID reader 104 can be normally powered off. In response to a particular triggering mechanism, the passive RFID reader 104 can be turned/powered on in order to collect information from an RFID tag, as is further described herein. The triggering mechanism can be, in some examples, a sensor detecting a user accessing the storage bin 106, as is further described in connection with FIG. 4.

As previously described above, a user can access the kiosk device 102. The user can access the kiosk device 102 in order to access items 108, 110 included in the storage bin 106. For example, a user may want to utilize first item 108 and can accordingly gain access to first item 108 by accessing storage bin 106, as is described herein.

A user can access storage bin 106 in order to remove first item 108 from storage bin 106. As used herein, the term “item” refers to any object that can be placed/stored/accessed in storage bin 106. For example, first item 108 can be, for instance, a cable such as a universal serial bus (USB)-C cable. A user may utilize the first item 108 (e.g., the USB-C cable) for various purposes, but the user may not have the USB-C cable available, so the user can access storage bin 106 in order to remove the first item 108 from the storage bin 106 for use.

Although the first item 108 is described above as being a USB-C cable, examples of the disclosure are not so limited. For example, first item 108 can be a micro-USB and/or Lightning cable. Additionally, although first item 108 is described as being a USB cable, examples of the disclosure are not so limited. For example, the first item 108 can be any other component of a computing device, and/or can be a computing device itself. As used herein, the term “computing device” can be, for example, a laptop computer, a desktop computer, or a mobile device (e.g., a smart phone, tablet, personal digital assistant, smart glasses, a wrist-worn device, etc.), among other types of computing devices. As used herein, the term “mobile device” refers to a device that are (or can be) carried and/or worn by a user. A mobile device can include a phone (e.g., a smart phone), a tablet, a personal digital assistant (PDA), smart glasses, and/or a wrist-worn device (e.g., a smart watch), among other types of mobile devices. Further, second item 110 can be any component of a computing device and/or can be a computing device itself, including but not limited to the examples of computing devices and components thereof described above.

The first item 108 can include an RFID tag 109 associated with the first item 108. For example, the RFID tag 109 can be attached to the first item 108 (e.g., via a zip-tie, Velcro tie, and/or other attachment mechanism). The RFID tag 109 can be associated with the first item 108. Accordingly, in response to the first item 108 being removed from the storage bin 106, the RFID reader 104 can record the removal of the first item 108 via the RFID tag 109 associated with the first item 108.

The RFID reader 104 can record the removal of the first item 108 from an item inventory of the storage bin 106. As used herein, the term “item inventory” refers to a listing of an amount and/or type of an item. For example, the item inventory of storage bin 106 can include the first item 108 and the second item 110. In response to the removal of the first item 108 from the storage bin 106, the RFID reader 104 can record the removal of the first item 108 such that the item inventory of the storage bin 106 can be recorded/updated (e.g., from two items to one item).

As is further described herein, the first item 108 and the second item 110 can be the same item such that the item inventory of the storage bin 106 can include two items of the same type. In some examples, the first item 108 and the second item 110 can be different items such that the item inventory of the storage bin 108 can include two items, one item of a first type and one item of a second type.

Although the storage bin 106 is described above as including two items (e.g., first item 108 and second item 110), examples of the disclosure are not so limited. For example, the storage bin 106 can include less than two items or more than two items.

In some examples, the storage bin 106 can include the first item 108, but the second item 110 may have been removed and can be returned to the storage bin 106. The RFID reader 104 can record the addition of the second item 110 to an item inventory of the storage bin 106. For example, the item inventory of storage bin 106 can include the first item 108. In response to the addition of the second item 110 to the storage bin 106, the RFID reader 104 can record the addition of the second item 110 such that the item inventory of the storage bin 106 can be recorded/updated (e.g., from one item to two items).

As previously described above, the RFID reader 104 can be normally powered off. In response to the first item 108 being removed from the storage bin 106, the RFID reader 104 can be powered on. The RFID reader 104 can be powered on to record the removal of the first item 108 from the storage bin 106. Similarly, in response to the second item 110 being added to the storage bin 106, the RFID reader 104 can be powered on. The RFID reader 104 can be powered on to record the addition of the second item 110 to the storage bin 106. The RFID reader 104 can be powered on in response to a trigger mechanism, as is further described in connection with FIGS. 2 and 4.

FIG. 2 illustrates an example of a kiosk device 202 having storage bins 206 consistent with this disclosure. The kiosk 202 can include an RFID reader 204, a storage bin 206, and a controller 214.

As previously described in connection with FIG. 1, the kiosk device 202 can include the storage bin 206. The storage bin 206 can include items such as first item 208 and/or second item 210, among other items. Additionally, the kiosk device 202 can include the RFID reader 204. The RFID reader 204 can be a passive RFID reader that is normally powered off until, in response to a particular triggering mechanism, the passive RFID reader 204 can be powered on to collect information from an RFID tag, as is further described herein. The triggering mechanism can be, in some examples, a sensor detecting a user accessing the storage bin 206, as is further described in connection with FIG. 4.

As previously described in connection with FIG. 1, in some examples a user may not have a particular item, such as a cable, available to the user for use. Accordingly, a user may access the kiosk device 202 in order to retrieve an item (e.g., a cable) for use, as is further described herein.

In order to access the storage bin 206 of the kiosk device 202, a user can input an access request into the kiosk device 202. As used herein, the term “access request refers to a petition/solicitation for an ability/permission for admittance to the storage bin 206. A user can input an access request via an input mechanism (not illustrated in FIG. 2). An input mechanism can include a badge reader, card reader, keypad, touch-screen display, and/or biometric scanner, among other examples of input mechanisms. For example, a user can swipe a badge, security key, and/or access card (e.g., via a badge and/or card reader), enter a passcode (e.g., via a keypad/touch-screen display), enter a biometric input (e.g., such as a facial scan, eye scan, fingerprint, voice input, etc.), among other types of access requests.

The controller 214 can determine a user identity associated with a received access request for the storage bin 206 of the kiosk device 202. As used herein, the term “user identity” refers to a logical entity used to identify a user on a system. For example, a user identity can be an entity that corresponds to a particular user to identify the particular user for the kiosk device 202.

For example, the access request received by the kiosk device 202 can include and/or correspond to user credentials. The user credentials can correspond to a user identity. For example, a user can swipe an access card that includes user credentials corresponding to the user swiping the access card. The user credentials can include identifying information about the user (e.g., the user's name, date of birth, address, etc.). For instance, a first user can swipe an access card associated with the first user at an input device of the kiosk device 202. The controller 214 can determine, utilizing the user credentials from the access card, a user identity associated with the first user.

The controller 214 can grant access to the storage bin 206 based on the determined user identity. For example, in response to the user identity having access rights to the storage bin 206, the controller 214 can grant access to the storage bin 206. In some examples in which a user may not have access rights to the storage bin 206, the controller can deny access to the storage bin 206.

In some examples, the controller 214 can update the inventory of the storage bin 206 in response to granting access to the storage bin 206 based on the determined user identity. For example, the storage bin 206 can include first item 208 and second item 210. The controller 214 can cause the RFID reader 204 to read the RFID tags 209, 211 associated with the items 208, 210, respectively, located in the storage bin 206 in order to update the inventory of the storage bin 206 to include the two items 208 and 210.

The controller 214 can determine, via the RFID reader 204 in response to the storage bin 206 being accessed, details regarding an item transiting the storage bin via an RFID tag associated with the item. As used herein, the term “transiting” refers to an item being placed in the storage bin 206 and/or being removed from the storage bin 206. For example, a user can input an access request into the kiosk device 202 and the controller 214 can grant access to the storage bin 206 for the user. The user can remove the first item 208 from the storage bin 206. As a result of the first item 208 being removed from or being added to (e.g., transiting) the storage bin 206, the controller can determine details regarding the first item 208 via the RFID reader 204 and the RFID tag 209 associated with the first item 208.

As used herein, the term “details” refers to characteristics about items included in the storage bin 206. For example, the controller can determine details regarding the items transiting the storage bin 206 including a type of item transiting the storage bin 206, an amount of the item transiting the storage bin 206, and/or whether the item is being added to the storage bin 206 and/or being removed from the storage bin 206, among other details regarding items transiting the storage bin 206, as is further described herein.

The controller can determine the details regarding the item 208, 210 transiting the storage bin 206 by determining a type of the item 208, 210. The type of the item can be included in the RFID tag associated with the item. In some examples, the first item 208 can be a Micro-USB cable, and the RFID tag 209 can include the cable type of the first item 208 as a Micro-USB cable, among other examples. In some examples, the second item 210 can be a mobile device, and the RFID tag 211 can include the brand name, model number, etc. of the second item 210 as the mobile device, among other examples. Accordingly, the RFID reader 204 can determine the type of the item 208, 210 based on the RFID reader 204 scanning (e.g., in response to the item 208, 210 being added to the storage bin 206) or not being able to scan (e.g., in response to the item 208, 210 being removed from the storage bin 206) the RFID tags 209, 211 associated with the first item 208 and the second item 210, respectively, as is further described herein.

The controller 214 can determine the details regarding the item 208, 210 transiting the storage bin 206 by determining whether the item is removed from the storage bin 206 or added to the storage bin 206. The details regarding whether the item 208, 210 is added to and/or removed from the storage bin 206 can be determined based on a signal from the RFID tag 209, 211 associated with the item 208, 210, respectively, read by the RFID reader 204.

For example, first item 208 can be removed from the storage bin 206 by a user. While the first item 208 is located in the storage bin 206, the RFID tag 209 associated with the first item 208 is readable by the RFID reader 204. When the storage bin 206 is accessed and the first item 208 is removed from the storage bin 206, the RFID tag 209 associated with the first item 208 can be moved a threshold distance away from the RFID reader 204 such that the RFID reader 204 can no longer read the RFID tag 209. Accordingly, the controller 214 can determine that first item 208 has been removed from storage bin 206.

In some examples, the RFID reader 204 can scan for (e.g., attempt to read) the RFID tag 209 in response to the storage bin 206 being closed. For example, the storage bin 206 can be a drawer and in response to the drawer being slid back into the kiosk device 202, the RFID reader 204 can scan for RFID tags. In response to the RFID reader 204 not being able to read RFID tag 209, the controller 214 can determine the details regarding first item 208 transiting the storage bin 206 (e.g., first item 208 was removed from the storage bin 206). In some examples, RFID reader 204 can scan for RFID tags 209, 211 and compare RFID tags read by the RFID reader 204 to a previous inventory. For instance, as previously described above, the RFID reader 204 can update the inventory of the storage bin 206 in response to granting access to the storage bin 206. The RFID reader 204 can complete the scan for RFID tags 209, 211, and compare with the previous inventory performed when access was granted to the storage bin 206 to determine that RFID tag 209 is not readable (e.g., as first item 208 has been removed from the storage bin 206). Accordingly, the controller can determine that the first item 208 was removed from the storage bin 206.

As another example, second item 210 can be added to the storage bin 206 by a user. For example, a user may have accessed storage bin 206 in the past to remove a mobile device (e.g., second item 210) and is now attempting to return the second item 210 to the kiosk device 202. While the second item 210 is located outside of the storage bin 206, the RFID tag 211 associated with the second item 210 is not readable by the RFID reader 204. When the storage bin 206 is accessed and the second item 210 is added to the storage bin 206, the RFID tag 211 associated with the second item 210 can be moved to within a threshold distance from the RFID reader 204 such that the RFID reader 204 can read the RFID tag 211. Accordingly, the controller 214 can determine that second item 210 has been added to the storage bin 206.

In some examples, the RFID reader 204 can scan for (e.g., attempt to read) the RFID tag 211 in response to the storage bin 206 being closed. For example, the storage bin 206 can be a drawer and in response to the drawer being slid back into the kiosk device 202, the RFID reader 204 can scan for RFID tags. In response to the RFID reader 204 being able to read RFID tag 211, the controller 214 can determine the details regarding the second item 210 transiting the storage bin 206 (e.g., second item 210 was added to the storage bin 206). In some examples, RFID reader 204 can scan for RFID tags 209, 211 and compare RFID tags read by the RFID reader 204 to a previous inventory. For instance, as previously described above, the RFID reader 204 can update the inventory of the storage bin 206 in response to granting access to the storage bin 206. The RFID reader 204 can compare the scan for RFID tags 209, 211, and compare with the previous inventory performed when access was granted to the storage bin 206 to determine that RFID tag 211 is readable (e.g., as second item 210 has been added to the storage bin 206). Accordingly, the controller can determine that the second item 210 was added to the storage bin 206.

Based on the determined details regarding the item 208, 210 transiting the storage bin 206, the controller 214 can update an inventory of the storage bin 206. For example, in response to controller 214 determining first item 208 was removed from storage bin 206, controller 214 can update the inventory of the storage bin 206 to reflect the removal of the first item 208 from the storage bin 206. Additionally, in response to the controller 214 determining the second item 210 was added to the storage bin 206, the controller 214 can update the inventory of the storage bin 206 to reflect the addition of the second item 210 to the storage bin 206.

As previously described above, the controller 214 can determine a user identity associated with a received access request for the storage bin 206. The controller 214 can associate the determined user identity with the details regarding the item 208, 210 transiting the storage bin 206. For example, the controller 214 can associate the user identity with the first item 208 having been removed from the storage bin 206 and/or the user identity with the second item 210 having been added to the storage bin 206. Associating a user identity with transiting items 208, 210 can allow for inventory tracking of items included in the storage bin 206. For example, a kiosk administrator can easily determine a user associated with an item 208, 210 which has been removed from the storage bin 206, how many items 208, 210 the user has removed, whether the items 208, 210 have been returned, etc. Additionally, the kiosk administrator can determine a user associated with an item 208, 210 who last removed the item 208, 210 in the event the item 208, 210 is damaged, destroyed, etc.

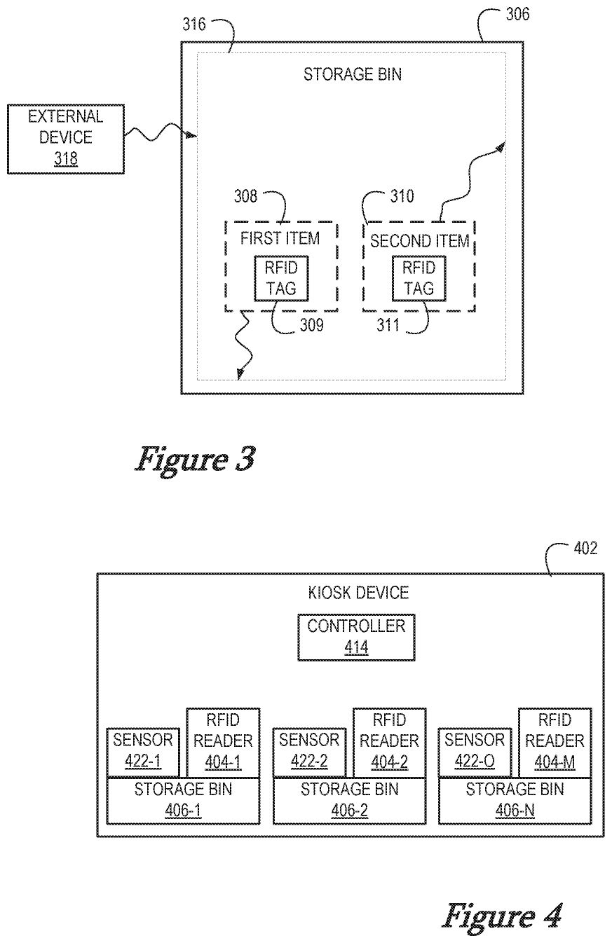

FIG. 3 illustrates an example of a storage bin 306 consistent with this disclosure. Storage bin 306 can include the first item 308 and the second item 310. The first item 308 can include associated RFID tag 309 and the second item 310 can include associated RFID tag 311.

As illustrated in FIG. 3, the storage bin 306 can include a lining 316. As used herein, the term “lining” refers to a layer of material on an inner surface of the storage bin 306. For example, the lining 316 can be located on the inner surface of the storage bin 306.

The lining 316 can be of a material to block electromagnetic signals into the storage bin 306 and/or out of the storage bin 306. For example, the lining 316 can block an electromagnetic signal from an external device 318 from entering the storage bin 306. Blocking an electromagnetic signal from an external device 318 can prevent a malicious user from scanning RFID tags 309, 311 to learn the contents of the storage bin 306. This can prevent thefts and/or damage to the kiosk device including the storage bin 306.

In some examples, the first item 308 and/or the second item 310 can be a mobile device. The lining 316 can prevent the mobile device(s) from communicating with an external network. For example, the lining 316 can prevent a mobile device from communicating with a mobile network, a local area network (LAN), wireless LAN (WLAN), etc. Accordingly, the lining 316 can preserve battery life of the mobile device(s).

As described above, the lining 316 can block electromagnetic signals from entering and/or exiting the storage bin 306. The material of lining 316 can be an electromagnetic field (EMF) shielding material, including materials having static dissipative coatings, aluminum, polyethylene, polyester, silver, copper wire mesh, aluminum mesh, among other EMF shielding materials.

FIG. 4 illustrates an example of a kiosk device 402 having storage bins 406 consistent with this disclosure. The kiosk device 402 can include controller 414, storage bins 406-1, 406-2, 406-N (e.g., referred to collectively as storage bins 406), RFID readers 404-1, 404-2, 404-M (e.g., referred to collectively as RFID readers 404), and sensors 422-1, 422-2, 422-0 (e.g., referred to collectively as sensors 422).

As previously described in connection with FIG. 1, the kiosk device 402 can include storage bins 406-1, 406-2, 406-N. The storage bins 406-1, 406-2, 406-N can include items (e.g., such as items 108, 208, 308, 110, 210, 310, previously described in connection with FIGS. 1-3, respectively).

Additionally, the kiosk device 402 can include RFID readers 404-1, 404-2, 404-M. The RFID readers 404-1, 404-2, 404-M can be passive RFID readers that are normally powered off until, in response to a particular triggering mechanism, the passive RFID readers 404-1, 404-2, 404-M are powered on to collect information from RFID tags associated with items included in the storage bins 406-1, 406-2, 406-N, as is further described herein.

As illustrated in FIG. 4, the kiosk device 402 can include sensors 422-1, 422-2, 422-0. As used herein, the term “sensor” refers to a device to detect events and/or changes in its environment and transmit the detected events and/or changes for processing and/or analysis. For example, the sensor can detect events or changes, such as a user accessing (e.g., sliding out or in, in the case of a drawer) the storage bin 406. Sensors 422-1 can include an ultrasonic detector, passive infrared motion detector, magnetic switch, photoelectric beam, among other types of sensors.

As previously described herein, the RFID readers 404-1, 404-2, 404-M can be passive RFID readers that are normally powered off until, in response to a particular triggering mechanism, the passive RFID readers 404-1, 404-2, 404-M are powered on to collect information from RFID tags associated with items included in the storage bins 406-1, 406-2, 406-N. The triggering mechanism can be, in some examples, a sensor 422-1, 422-2, 422-0 detecting a user accessing the storage bin 406. For example, sensor 422-1 can detect a user accessing storage bin 406-1 and accordingly, controller 414 can cause the RFID reader 404-1 to power on to collect information from RFID tags associated with items included in the storage bin 406-1. In other words, the controller 414 can cause the RFID reader 404-1 of the kiosk device 402 to power on to read an RFID tag associated with an item being removed from storage bin 406-1 and/or an item being added to storage bin 406-1 in response to a sensor 422-1 detecting the storage bin 406-1 being accessed. In response to the user closing the storage bin 406-1, the RFID reader 404-1 can power off.

As illustrated in FIG. 4, the kiosk device 402 can include three storage bins 406-1, 406-2, 406-N. However, examples of the disclosure are not so limited. For example, the kiosk device 402 can include less than three storage bins or more than three storage bins.

Additionally, as illustrated in FIG. 4, the kiosk device 402 can include three RFID readers 404-1, 404-2, 404-M each corresponding to a storage bin 406-1, 406-2, 406-N, respectively. However, examples of the disclosure are not so limited. For example, the kiosk device 402 can include less than three RFID readers 404-1, 404-2, 404-M or more than three RFID readers 404-1, 404-2, 404-M.

Additionally, as illustrated in FIG. 4, each RFID reader 404 can include a scannable coverage area to read RFID tags corresponding to each storage bin 406. That is, RFID reader 404-1 can include a coverage area corresponding to storage bin 406-1, RFID reader 404-2 can include a coverage area corresponding to storage bin 406-2, and RFID reader 404-M can include a coverage area corresponding to storage bin 406-N. However, examples of the disclosure are not so limited. For example, RFID reader 404-2 can include a coverage area corresponding to storage bins 406-1 and 406-2 and/or 406-N. In other words, the kiosk device 402 can include an amount of RFID readers 404 having coverage areas that don't necessarily correspond to a particular storage bin 406. That is, one RFID reader 404 can cover one storage bin 406, or can cover more than one storage bin 406.

In some examples, a kiosk administrator may have to perform routine maintenance and/or adjust inventory levels of storage bins 406 of the kiosk device 402. Accordingly, the kiosk administrator can cause the kiosk device 402 to enter an inventory adjustment mode in response to an input to the kiosk device 402. For example, the kiosk administrator can swipe a unique badge, unique security key, and/or unique access card (e.g., via a badge and/or card reader), enter a unique passcode (e.g., via a keypad/touch-screen display), enter a biometric input (e.g., such as a facial scan, eye scan, fingerprint, voice input, etc.), among other types of inputs to cause the kiosk device 402 to enter the inventory adjustment mode.

When in the inventory adjustment mode, the inventory of storage bins 406 can be adjusted. For example, the total amount of items included in a storage bin 406 can be adjusted (e.g., from 75 items to 100 items, from 70 items to 50, etc.) so that the controller 414 knows the total inventory of items in a particular storage bin of the storage bins 406. Further, the kiosk administrator can perform routine maintenance on the kiosk/storage bins 406, clean the kiosk device 402/storage bins 406, replace parts, etc.

Kiosk devices having storage bins, according to the disclosure, can allow for items to be distributed and/or received from users. The inventory of the items included in the storage bins of the kiosks can be easily tracked which can ensure an accurate inventory list of the items associated with the kiosk device. Further, items can be associated with users such that users can be notified about and/or charged for items which have not been returned or are returned in a damaged or non-functioning condition.

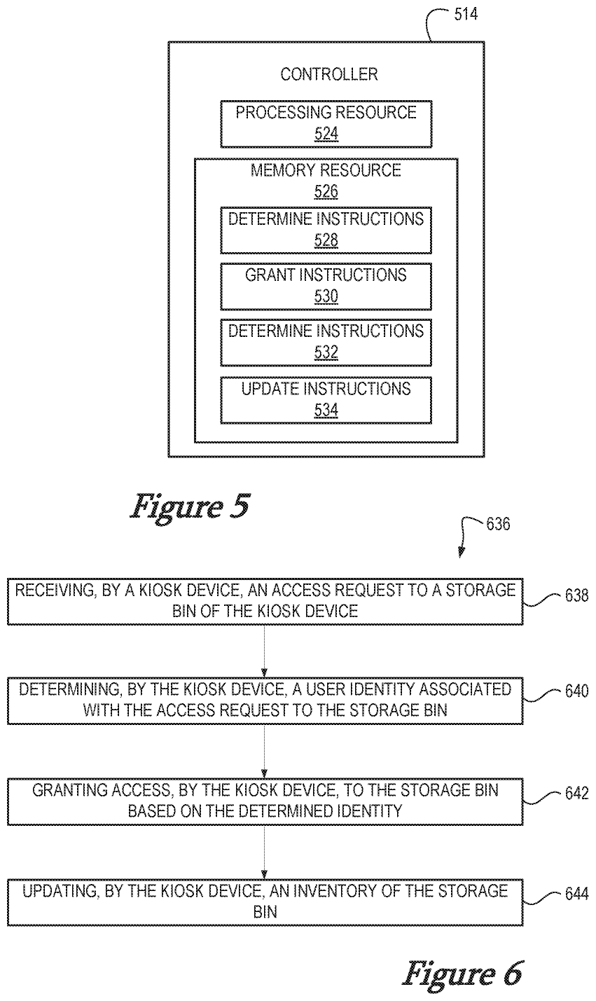

FIG. 5 illustrates an example of a controller 514 of a kiosk device having storage bins consistent with this disclosure. As described herein, the controller 514 may perform functions related to a kiosk device having storage bins. Although not illustrated in FIG. 5, the controller 514 may include a processor and a machine-readable storage medium. Although the following descriptions refer to a single processor and a single machine-readable storage medium, the descriptions may also apply to a system with multiple processors and multiple machine-readable storage mediums. In such examples, the controller 514 may be distributed across multiple machine-readable storage mediums and the controller 514 may be distributed across multiple processors. Put another way, the instructions executed by the controller 514 may be stored across multiple machine-readable storage mediums and executed across multiple processors, such as in a distributed or virtual computing environment.

Processing resource 524 may be a central processing unit (CPU), a semiconductor-based microprocessor, and/or other hardware devices suitable for retrieval and execution of machine-readable instructions 528, 530, 532, 534 stored in a memory resource 526. Processing resource 524 may fetch, decode, and execute instructions 528, 530, 532, 534. As an alternative or in addition to retrieving and executing instructions 528, 530, 532, 534, processing resource 524 may include a plurality of electronic circuits that include electronic components for performing the functionality of instructions 528, 530, 532, 534.

Memory resource 526 may be any electronic, magnetic, optical, or other physical storage device that stores executable instructions 528, 530, 532, 534 and/or data. Thus, memory resource 526 may be, for example, Random Access Memory (RAM), an Electrically-Erasable Programmable Read-Only Memory (EEPROM), a storage drive, an optical disc, and the like. Memory resource 526 may be disposed within controller 514, as shown in FIG. 5. Additionally, memory resource 526 may be a portable, external or remote storage medium, for example, that causes controller 514 to download the instructions 528, 530, 532, 534 from the portable/external/remote storage medium.

The controller 514 may include instructions 528 stored in the memory resource 526 and executable by the processing resource 524 to determine a user identity associated with a received access request for the storage bin. For example, the kiosk device can receive an access request which can include user credentials. The user credentials can correspond to a user identity. The controller 514 can determine, utilizing the user credentials, a user identity associated with a user inputting an access request to the kiosk device.

The controller 514 may include instructions 530 stored in the memory resource 526 and executable by the processing resource 524 to grant access to the storage bin based on the determined user identity. For example, in response to the user identity having access rights to the storage bin, the controller 514 can grant access to the storage bin. In some examples in which a user may not have access rights to the storage bin, the controller 514 can deny access to the storage bin.

The controller 514 may include instructions 532 stored in the memory resource 526 and executable by the processing resource 524 to determine, via an RFID reader in response to the storage bin being accessed, details regarding an item transiting the storage bin via an RFID tag associated with the item. For example, the controller 514 can determine characteristics including a type of item transiting the storage bin, an amount of the item transiting the storage bin, and/or whether the item is being added to the storage bin or being removed from the storage bin. The RFID reader can determine the details regarding the item transiting the storage bin based on a signal from the RFID tag read by the RFID reader.

The controller 514 may include instructions 534 stored in the memory resource 526 and executable by the processing resource 524 to update an inventory of the storage bin based on the determined details regarding the item transiting the storage bin. For example, in response to the controller 514 determining a first item was removed from the storage bin, the controller 514 can update the inventory of the storage bin to reflect the removal of the first item from the storage bin. Additionally, in response to the controller 514 determining a second item was added to the storage bin, the controller 514 can update the inventory of the storage bin to reflect the addition of the second item to the storage bin.

FIG. 6 illustrates an example of a method 636 for a kiosk device having storage bins consistent with this disclosure. For example, method 636 can be performed by a kiosk device (e.g., kiosk device 102, 202, 402, previously described in connection with FIGS. 1, 2, and 4, respectively).

At 638, the method 636 includes receiving, by a kiosk device, an access request to a storage bin of the kiosk device. For example, the kiosk device can receive an access request which can include user credentials.

At 640, the method 636 includes determining, by the kiosk device, a user identity associated with the access request to the storage bin. The user credentials can correspond to a user identity, and a controller of the kiosk device can determine, utilizing the user credentials, a user identity associated with a user inputting an access request to the kiosk device.

At 642, the method 636 includes granting access, by the kiosk device, to the storage bin based on the determined identity. For example, a user may have a device to be serviced and accordingly, may have a desire to obtain an item included in the kiosk device. The item may be utilized during the service of the device, may be a backup device while the user's device is being serviced, may be a part to utilize during servicing of the device, among other examples. In response to the user identity having access rights to the storage bin, the controller of the kiosk device can grant access to the storage bin. The user can, accordingly, access an item or items included in the storage bin. In some examples in which a user may not have access rights to the storage bin, the controller of the kiosk device can deny access to the storage bin.

At 644, the method 636 includes updating, by the kiosk device, an inventory of the storage bin. In some examples, the inventory of the storage bin can be updated in response to an item being removed from the storage bin based on a passive (e.g., normally off) RFID reader of the kiosk device powering on to read an RFID tag associated with the item being removed from the storage bin. In some examples, the inventory of the storage bin can be updated in response to an item being added to the storage bin based on a passive (e.g., normally off) RFID reader of the kiosk device powering on to read an RFID tag associated with the item being added to the storage bin. The RFID reader can be powered on in response to a sensor detecting access of the storage bin.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense. As used herein, the designators “M”, “N”, and “O”, particularly with respect to reference numerals in the drawings, indicate that a plurality of the particular feature so designated can be included with examples of the disclosure. The designators can represent the same or different numbers of the particular features.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A kiosk device, comprising:
a passive radio frequency identification (RFID) reader; and
a storage bin;
wherein:
in response to a first item being removed from the storage bin, the RFID reader is to record the removal of the first item via an RFID tag associated with the first item; and
in response to a second item being added to the storage bin, the RFID reader is to record the addition of the second item via an RFID tag associated with the second item.

2. The kiosk device of claim 1, wherein the RFID reader is to record the removal of the first item in an item inventory of the storage bin.

3. The kiosk device of claim 1, wherein the RFID reader is to record the addition of the second item in an item inventory of the storage bin.

4. The kiosk device of claim 1, wherein:
the passive RFID reader is normally powered off; and
in response to the first item being removed from the storage bin or the second item being added to the storage bin, the passive RFID reader is powered on.

5. The kiosk device of claim 4, wherein:
the kiosk device includes a sensor;
the normally powered off passive RFID reader is powered on in response to the sensor detecting the storage bin being accessed to at least one of remove the first item from the storage bin or add the second item to the storage bin.

6. The kiosk device of claim 1, wherein the storage bin includes a lining of a material to block an electromagnetic signal at least one of into and out of the storage bin.

7. A kiosk device, comprising:
a passive normally off radio frequency identification (RFID) reader;
a storage bin; and
a controller comprising a processing resource that executes non-transitory machine-readable instructions stored in a memory resource to cause the controller to:
determine a user identity associated with a received access request for the storage bin;
grant access to the storage bin based on the determined user identity;
determine, via the RFID reader in response to the storage bin being accessed, details regarding an item transiting the storage bin via an RFID tag associated with the item; and
update an inventory of the storage bin based on the determined details regarding the item transiting the storage bin.

8. The kiosk device of claim 7, wherein the controller executes the instructions to determine the details regarding the item transiting the storage bin by determining a type of the item, wherein the item type is included in the RFID tag associated with the item.

9. The kiosk device of claim 7, wherein the controller executes the instructions to determine the details regarding the item transiting the storage bin by determining whether the item is removed from the storage bin or added to the storage bin based on a signal from the RFID tag read by the RFID reader.

10. The kiosk device of claim 7, wherein the controller further includes instructions to cause the controller to update the inventory of the storage bin in response to granting access to the storage bin based on the determined user identity.

11. The kiosk device of claim 7, wherein the controller further includes instructions to cause the controller to cause the kiosk device to enter an inventory adjustment mode in response to an input, wherein the inventory of the storage bin is adjusted in the inventory adjustment mode.

12. A method, comprising:
receiving, by a kiosk device, an access request to a storage bin of the kiosk device;
determining, by the kiosk device, a user identity associated with the access request to the storage bin;
granting access, by the kiosk device, to the storage bin based on the determined identity;
updating, by the kiosk device, an inventory of the storage bin in response to at least one of:
an item being removed from the storage bin based on a passive normally off radio frequency identification (RFID) reader of the kiosk device powering on to read an RFID tag associated with the item being removed from the storage bin; and
an item being added to the storage bin based on the RFID reader of the kiosk device powering on to read an RFID tag associated with the item being added to the storage bin.

13. The method of claim 12, wherein the method includes causing the RFID reader of the kiosk device to power on to read the RFID tag associated with the item being removed from the storage bin in response to a sensor detecting the storage bin being accessed.

14. The method of claim 12, wherein the method includes causing the RFID reader of the kiosk device to power on to read the RFID tag associated with the item being added to the storage bin in response to a sensor detecting the storage bin being accessed.

15. The method of claim 12, wherein the method includes associating the user identity with at least one of:
the item being removed from the storage bin; and
the item being added to the storage bin.
